(19) United States
(12) Patent Application Publication
(10) Pub. No.: US 2007/0269071 A1
(43) Pub. Date: Nov. 22, 2007

(54) Non-Planar Transducer Arrays

(75) Inventor: Anthony Hooley, Cambridge (GB)

Correspondence Address: HARNESS, DICKEY & PIERCE, P.L.C., P.O. BOX 828, BLOOMFIELD HILLS, MI, 48303, US

(73) Assignee: 1...LIMITED, Cambridge (GB)

(21) Appl. No.: 11/660,029

(22) PCT Filed: Aug. 10, 2005
(86) PCT No.: PCT/GB05/03140

§ 371 Date: Feb. 9, 2007

(30) Foreign Application Priority Data
Aug. 10, 2004 (GB) 0417712.7
Jan. 29, 2005 (GB) 0501879.1

(51) Int. Cl. H04R 1/40; H04R 1/02; H04R 9/06

(52) U.S. Cl. 381/336; 381/335; 381/182

(57) ABSTRACT

Non-planar acoustic arrays are disclosed in which the plurality of transducers lie on a curved surface. The curved surface preferably subtends at least 90° and, in a preferred embodiment of the invention is a closed convex surface such as a cylinder. The curvature of the surface allows beams to be directed in a greater variety of directions. Apparatus and methods are disclosed in which only certain of the transducers are used for beam-forming, in accordance with the position of the transducer relative to the desired beam.

The invention relates to apparatus and methods for creating a sound field, preferably using arrays of sonic output transducers. The invention concerns the development of an array having a curved surface.

In several co-owned international published patent applications, e.g. WO01/23104, WO02/078388 acoustic digital delay array loudspeaker systems (hereinafter referred to as digital-delay array antennas (DDAA) or more simply as Arrays) are described, most of which are planar or substantially planar in their arrangement of the transducers comprising the Array. Some variants described have the Array supplemented with one or more additional (often “woofer” type) transducers which may or may not be substantially within the plane of the Array proper, but these generally provide auxiliary functions such as non-steered reproduction of low frequencies (“bass”). In another co-owned patent application (EP 0,818,122-A) a non-planar Array is described wherein multiple successive “layers” of transducers are placed one behind the other, each successive further-from-front layer emitting its sound via “gaps” in the layer or layers in front of that layer, thus building up a three-dimensional (3D) Array of transducers. However, the effective radiating surface in this case is just the outer layer of transducers plus its radiating gaps (emitting radiation from the transducers behind) which is therefore effectively planar. Essentially planar Arrays with some slight curvature in the 2D surface containing the radiating elements are also anticipated in these applications. However no development of these arrays has taken place. It was thought that it is best to minimise the curvature of the Array so as to avoid “shadowing” of certain transducers from certain beam angles (i.e. positions in the near or far field where certain transducers are no longer visible because of occlusion by the front surface of the curved Array), and also because real transducers have finite beam-width of their own at the higher frequencies due to their radiating diameters becoming comparable in size with the wavelength of radiated sound, and thus individual transducers begin to beam in their individual “straight-ahead” directions. In a planar Array such individual transducer beaming directions at least all point in substantially the same direction and cause more predictable effects on the beam shape and radiated power.

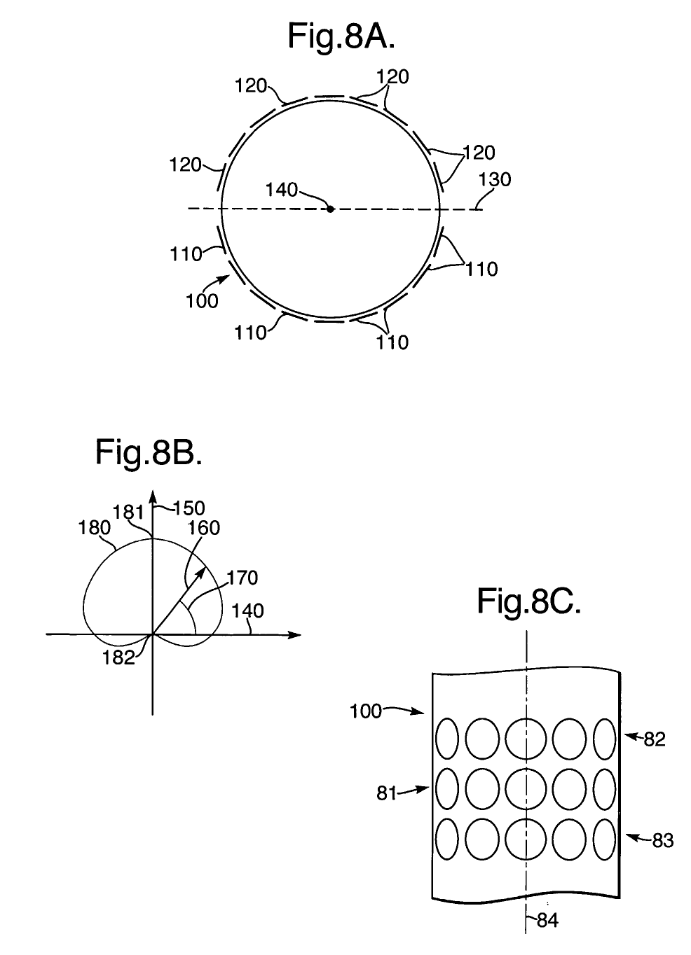

Also known for planar arrays is the technique of Apodization, or Windowing or element-weighting. Essentially, Apodization is a technique whereby quite separately from the differential timing of signals to each array element (determined by the required beam direction and shape requirements), the elements are also additionally each given a possibly unique “weight” or gain setting (nominally in the range 0 to 1, or more generally in the range −1 to +1), in order to further refine the beam shape. If all these weights w are unity, then the array is said to be unweighted, or non-apodized. Typically, a non-apodized array will produce a narrow beam but with significant side-lobes (unrelated to alias sidelobes which are due to too coarse a spacing of array elements). A useful apodization weights the array elements down more, the further they are from the centre of the array, and in some cases the array weights w taper towards zero at the edge of the array. When this is done, the array beam becomes somewhat broader, but the sidelobes can be very greatly reduced in amplitude, by many tens of dB. This works essentially because an unweighted array has an abrupt change in signal sensitivity (whether transmitting or receiving) at the edges of the array, where the change is from w Oust within the edge of the array) to zero Oust outside the array). Because the beam pattern is related to the Fourier transform of the aperture “illumination function” (essentially proportional to the aperture weighting or apodization function), any abrupt change in the one will lead to sinc function-like (sinc==sin(x)/x) or sinc² function-like oscillations in the other, which manifest themselves as beam sidelobes. By tapering (i.e. applying weighting to) the edges of the aperture (with common functions such as raised cosines, or even linear tapers towards the aperture edge) the Fourier transform of the illumination function has reduced ripple, and thus the antenna has reduced sidelobes. Such a tapering function is shown in FIG. 9.

Furthermore, if an antenna beamshape is required that is essentially flat over some angular distance, then again, noting the Fourier transform relation between the domains, it is clear that a sinc weighting of the aperture (where some weights w are negative) will have the desired effect, as the Fourier transform of a sinc function is a square pulse (i.e. flat topped).

However, all of the above described prior art applies only to planar, or flat, DDAAs. In this invention we consider non-planar DDAAs, where the array elements are no longer arranged on a plane, but more generally on a 3D surface of some kind, or more generally still, throughout a 3D volume. In what follows we describe an apodization technique that solves some hitherto unforeseen problems with 3D arrays, as exemplified by a cylindrical DDAA (where the transducer elements of the array are arranged in some pattern (not necessarily uniform) over the surface of a cylinder), but it should be noted that the techniques described are generalisable to all 3D DDAA structures, with uniform or nonuniform element distributions, whether for receiving or transmitting DDAAs, and whatever form of waves (e.g. acoustic, electromagnetic, other) are being transduced, and are to be included as part of the invention.

Arrays of the present invention are preferably deliberately highly curved in 2D and 3D and take advantage of the effects of individual transducer beaming directions where relevant. Such curved arrays can usefully be cylindrical, conical, spherical, ellipsoidal, or other 2D surface and 3D bulk/solid distributions of transducers, and sections of such closed surfaces—e.g. hemispheres, spherical caps, half, quarter, three-quarter etc cylinders and cones, and other segments of complete surface and volume distributions of transducers.

In a first aspect of the invention, there is provided an apparatus for creating a sound field, said apparatus comprising: an array of sonic output transducers, which array is capable of directing at least one sound beam in a selected direction; wherein said transducers lie on a curved surface subtending 90° or more. Preferably, the transducers have their primary radiating direction perpendicular to the tangent of the curved surface at the point where they lie. The “primary radiating direction” is the direction which emits the maximum sound pressure level for that transducer. For standard cone transducers, the primary radiating direction is a line parallel to the longitudinal axis of the transducer, which line forms the rotational axis of symmetry for the transducer.

The curved surface is preferably a physical surface, which is to say the transducers are embedded in the surface such that the gaps between the transducers are filled with material. Alternatively, gaps between the transducers may not necessarily be filled with material or any such material in the gaps need not follow the curvature of the surface.

The digital delay array loudspeaker preferably comprises 4 or more transducers arranged in space in a substantially non-planar fashion, preferably with all transducers positioned such that their 3D centres of gravity lie in some smooth 3D highly curved surface, the 3D surface being open or closed. The curvature of the surface preferably has a single sign over its whole extent, which is to say that the curvature of the surface preferably does not change. The curvature of the surface is preferably convex with the transducers emitting sound out of the convex face of the surface. Preferred examples of such surfaces are cylinders, spheres, cones and segments thereof. The transducers are preferably each driven by a discrete signal processing channel including a uniquely selected per-transducer signal delay as per conventional prior-art Arrays, this delay being a function of the three-dimensional (3D) spatial position of the effective centre of acoustic radiation of that transducer (the transducer Position) and also a function of the beam shape that is to be produced by the Array; the signal amplitude sent to each transducer by its signal-processing channel is a function of the beam shape to be produced and possibly also a function of the Position of the transducer.

Where it is desired for the Array to produce a beam focussed on a point in space (Focal Point) then the signal processing delay (Delay1) for each transducer of the Array used to form the beam, is chosen such that this delay plus the respective delay (Delay2) caused by time-of-travel of sound from the Position of said transducer to the Focal Point (which latter delay is in general a function of the Position of said transducer) is a constant value for all transducers in the Array. Where other beam shapes are required, more complex Delay1 selection rules are needed.

Which transducers of the Array are used for the generation of any particular beam is largely a matter of choice, with the proviso that the more transducers of the Array used for a beam, the greater energy possible in the beam, using only those transducers which have line of sight to a point on the line of beaming direction, such as the Focal Point is preferable (as the remainder will only contribute to the energy at the Focal Point via diffraction, refraction and/or reflection), and the greater the physical separation in a plane normal to the beam direction of the set of transducers used to form a beam, then the higher the spatial resolution achievable, and finally the more tightly packed (i.e. the smaller the inter-transducer separation of neighbouring transducers used for a beam) the set of transducers used to form a beam, then the higher the frequency of sound that may be beamed without grating sidelobes forming. The transducers used are preferably only those that have an unimpeded component of radiation in a direction which contributes to the desired beam. In other words, transducers which are “shadowed” are not used and are preferably de-energised.

Multiple independent beams may be supported by the non-planar Array simultaneously, each carrying independent audio programme material and each being independently steerable and focussable, as is known in the prior art for planar Arrays, with the unique advantage that with the non-planar Array, the possibility of pointing separate beams simultaneously in essentially opposite directions becomes possible (a planar Array with a closed back is incapable of producing a beam in the half space behind the Array, i.e. the half space opposite to the direction in which the principal transducer radiation axes point; a non-planar Array of the present invention removes this limitation, completely in the case that the Array is a closed surface rather than just a segment of such a surface). The detailed acoustic construction of such curved Arrays can vary greatly, but effectively the “rear” acoustic radiation of each transducer in such an array is most preferably “contained” (i.e. prevented from contributing significantly to the externally felt radiation), either by setting each transducer into the otherwise closed-surface of a shared volume of fluid, generally air, or alternatively, by separately enclosing the rear of each transducer in its own closed volume. In either case, there are generally radiation efficiency advantages in having the transducer frontal radiating areas protrude from a commonly shared otherwise closed-surface.

The curved surface of the array preferably subtends more that 90°, such as 180° or 360°, so as to form a cylindrical array.

Thus for example, a cylindrical Array with transducers uniformly distributed over the cylinder's curved surface and where the circumference of the cylinder is large enough to accommodate more than two transducer diameters around it, and where the length of the cylinder is great enough to accommodate at least one transducer diameter (but preferably more, such as three or more), may be mounted with its axis vertical, in which case approximately half of the transducers (i.e. those half closest to the Focal Point where the focal distance is positive, and those half furthest from the Focal Point where the focal distance is negative, i.e. a virtual focus) may usefully be driven to project a sound beam to a focus in any horizontal direction (including the case where the Focal Point is at ±infinity). Preferably, six transducers or more are spaced apart around the circumferential direction of the cylinder.

Unlike with a planar Array where it is generally useful to recruit all of the transducers in the Array for a beam produced in any (possible) direction, with the non-planar Arrays of this invention it is advantageous to perform an additional step in the beam forming process, which is to calculate which of the Array's transducers may usefully contribute to a beam pointing in any specific direction, and then to only drive power for that beam into that subset of the transducers of the Array. Thus when sweeping a beam across a range of angles, two simultaneous processes are preferably carried out: 1) recalculating which transducers of the Array should be used for the beam as the direction changes. 2) recalculating the delays for each transducer participating in the beam so that the beam is produced in the desired direction; this additional process (transducer selection) is a new feature of the present invention. As described above, the method of calculating for each transducer whether or not it should be recruited for a given beam direction is essentially to compute whether or not that transducer has a line of sight to a point in the sound field, e.g. to the Focal Point—if it has it should be recruited for that beam direction, if not, it should preferably not be used. Refinements of the method may also take account of the frequency range being transmitted in the beam and the directionality of any given transducer at the upper frequency end of that range. Where a transducer with a line of sight to the Focal Point has a diameter large enough that it becomes highly directional at the upper end of the frequency range and is pointing in a direction sufficiently away from the direction to the Focal Point that its radiation pattern is weak (e.g. more than 3 dB down, or more than 6dB down) in the direction of the Focal Point, it may be advantageous to exclude that transducer from that beam direction as little will be gained by including it and transmission power will be wasted.

The first aspect thus also provides a method for creating a sound field, said method comprising: providing an array of sonic output transducers which lie on a curved surface subtending 90° or more; and directing a beam of sound using said array.

Returning to the example cylindrical Array described above, where the length of the cylindrical Array parallel to its axis is several to many transducer-diameters long, then the Array so formed will have significant directivity in a plane running through (and parallel to) the cylinder axis at sufficiently high frequencies (where the cylinder length is ˜>=wavelength of sound). New possibilities are now opened up for Arrays of the present invention, not possible with prior art planar arrays. For example, if the beam forming delays applied to transducers are now a function only of their distance along the axis of the cylinder of the array (and not a function of their angular displacement around the cylinder), then the Array will transmit a beam simultaneously (i.e. a fan beam) in all directions perpendicular to the cylinder axis, while the beam shape at right angles to this plane (i.e. in planes passing through and parallel to the axis) may be tailored by choice of delay function. Specifically a pencil beam in this plane may be achieved at any angle (latitude) from −pi rads to +pi rads relative to a plane perpendicular to the cylinder axis) whereupon the Focal Point previously described will open out into a Focal Circle (symmetrically positioned about the cylinder axis). Where the cylindrical Array is vertically disposed some distance above a nominally planar floor or ground surface, variation of the latitude angle will vary the distance from the Array where the beam intersects the floor. Choice of different delay functions can vary the beam shape around the beam direction independently of varying this beam (axis) intersection distance. Thus very flexible flood-coverage of floor areas is possible with such an Array. Furthermore, by selectively excluding some transducers at certain angles around the cylinder (longitude angles) from the beam, and/or by suitably applying delays to each transducer which are also a function of longitude angle, the otherwise circularly symmetric fan beam can be converted into a sector-of-circle fan beam, or indeed into several multiple sector fan beams, and the latitude angle of each such sector fan beam may be independently chosen.. Thus great selectivity of which areas of the surrounding ground/floor are covered by the beam or beams is possible. Furthermore, separate adjacent or non-adjacent regions of the surroundings may be flooded with different audio programmes simultaneously.

Where it is desired only that such a cylindrical Array be omnidirectional in the plane perpendicular to the cylinder axis, considerable savings on transducer drive amplifiers and signal processing electronics may be achieved by driving all transducers at the same (or nearly the same) position along the cylinder axis (irrespective of their angular position around said axis) with one and the same electrical drive signal produced by just one drive amplifier and signal processing channel. E.g. for a professional-audio Array with cylinder diameter of 1.1 m and 100 mm diameter 10 watt rated transducers, approximately 32 transducers may be positioned around each circumferential ring of the cylinder. Thus for a horizontally omnidirectional (only) Array (assuming the cylinder is mounted with axis vertical) just one 320W amplifier plus one signal processing channel could be used to drive the whole ring, a great saving in cost and complexity (eliminates 31 power amplifiers and signal processing chains, and associated wiring and connectors), especially as the cost of power amplifiers is only a weak function of their power rating in this region. Note that total flexibility of beam forming and steering in the direction parallel to the cylinder axis is still retained under this scheme, and in general conical-shell beams may be produced with any cone angle. Partial use of this idea may also be made resulting still in considerable cost savings; e.g. each semicircle or quadrant (or third, fifth, octant etc) of transducers of each circumferential ring could be driven with a power amplifier, resulting in elimination of 30 or 28 amplifiers and signal processing chains respectively.

In another variant of cylindrical arrays of the first aspect of the invention, transducers in regions on opposite sides of the (or an) axis of symmetry of the Array (e.g. the axis of the cylinder for a cylindrical array, or a diameter for a spherical array) may be driven in antiphase with optional relative drive power weighting. Consider for example the case where every other ring of transducers around the cylinder axis is driven totally in-phase, with the rings in-between these driven as two antiphase semicircles of transducers (with the separating diameters of all the antiphase rings aligned). Then the array behaves like a stack of dipole radiators alternating with monopole radiators, and the resulting overall response will be the classic cardioid polar distribution, with strong radiation in one direction and a complete null in the opposite direction. Variations on this simple arrangement abound, but an immediate possibility that arises with the 2D/3D Array implementation as described, of this cardioid radiator, is that the direction of maximum radiation can be altered at will by simple signal processing means (i.e. by selecting which subsets of transducers in each ring form the semicircular phase-opposed rings), thus enabling rapid and flexible beam sweeping or rotating, and in some applications, even more importantly, null-direction sweeping or rotating. The advantage of making a cardioid Array in this manner is that because of the large number of transducers (and the fine tuning available with the signal processing in phase/delay and amplitude) very accurately matched monopole and dipole sources may be synthesised thus giving a very sharp null to the radiation pattern.

The possibilities described above for a cylindrical Array design of the invention, may be carried over to the case where instead of cylindrical, the Array is made conical, or spherical. Where there is a well defined preferred latitude angle of radiation from the Array in a given application, there can be advantages (primarily in making best use of the radiation pattern of individual transducers at high frequencies) in using a conical rather than cylindrical array, with the cone angle such that the sloping sides of the cone are normal to that preferred latitude angle. Otherwise, the use considerations are essentially the same as for the cylindrical array previously described.

Where a spherical 2D surface array is used (transducers now being approximately uniformly distributed over the surface of a sphere) further advantages arise. Just as the cylindrical Array allows uniform beam coverage in 2 pi rads of one plane, use of a spherical Array allows 4 pi steradian coverage in 3-space, with beams freely being generated in any conceivable direction from the centre of the Array, and in particular, simultaneous beams in any 2 or more completely independent directions including opposite directions. This is impossible with conventional loudspeakers, and indeed with prior art planar Arrays. Applications for such true 3D capable beam forming arrays are particularly to be found in very large buildings (such as auditoria, concert halls (e.g. Royal Albert Hall), very large atrium structures, and underwater).

In another co-owned published international patent application (WO03/034780) are described reasons and techniques for using a non-uniform distribution of transducers over the surface of a planar Array. It should be noted that these reasons and techniques carry over to highly curved non-planar Arrays of the present invention, suitably adjusted for the new geometry, and in certain applications technical advantages may be achieved by use of such non-uniform transducer distributions (primarily the advantages are reduction of grating sidelobe amplitudes at the expense of some primary beam broadening), and it is intended that non-uniform transducer distribution variants of all of the geometric forms of Arrays described in the present invention should also form part of the present invention, as will be evident to those skilled in the art.

A second aspect of the invention provides apparatus for creating a sound field, said apparatus comprising: an array of sonic output transducers, which array is capable of directing at least one beam in a first selected direction; wherein said transducers lie on a curved surface; and wherein said apparatus comprises a processor arranged to determine a first subset of transducers to use when directing sound in said first direction.

There is also provided a method for creating a sound field, said method comprising: providing an array of sonic output transducers which lie on a curved surface; selecting a direction in which to beam sound; selecting a first subset of transducers in accordance with said direction such that said first subset contains only those transducers that have an unimpeded component of radiation in a direction which contributes to a beam in said selected direction; using only said first subset of transducers to beam sound in said selected direction.

In another aspect of the invention, Arrays of any 3D shape are volume-populated with array transducers—i.e. rather than simply covering the surface of a 3D volume (e.g. a cylinder, cone or sphere) with transducers, the space within the volume also contains transducers, and there is no “surface” as such. Indeed, as much as possible of the space surrounding each of the transducers should preferably be kept clear of solid materials (or other sound absorbing, reflecting or refracting substance) so as to minimally impede the acoustic radiation from each transducer. Transducers within such true 3D Arrays should preferably be 3D omnidirectional, and preferably monopole rather than dipole radiators, which implies that they either need to be small compared to a wavelength of sound at frequencies of interest, or, they should be of approximately spherically symmetric construction, at least at their radiating surface. Such a true 3D Array combines the directivity effects of both conventional planar Arrays (and highly curved Arrays of the first aspect of the present invention) with the directivity of end-fire arrays (end-fire arrays have significant extent compared to a wavelength in the direction of beaming, whereas planar arrays have significant extent at right angles to the direction of beaming). A 3D Array of the present invention combines the potentially full 4 pi steradian beam radiation characteristic of the previously described spherical highly curved Array, with the additional directivity achieved by simultaneous use of end-fire Array beaming. A practical 3D Array structure might usefully have the transducers mechanically connected by an open thin rod lattice of support members (each support member being effectively acoustically invisible by dint of its small cross section) thus forming a rigid overall structure without any sound-blocking panels or large surfaces other than the transducers themselves. The transducers will preferably be small in extent compared to wavelengths of interest so as to minimally affect the passage of sound energy from surrounding transducers by reflection, refraction and diffraction. The per transducer delays are calculated in a similar manner, for a given desired beam shape, as per prior art Arrays and first aspect invention Arrays; i.e. the delays are chosen such that radiation from each transducer arrives at the Focal Point simultaneously, taking into account their individual 3D coordinates. In this case however, unlike with the Arrays of the first aspect of the invention, it is not necessary to calculate which transducers to recruit for the production of a beam in any particular direction, as all transducers may equally participate, as there is no transducer shadowing, as there is no structure to throw (acoustic) shadows, other than the transducers themselves and their deliberately minimal support structures. Of course it is optionally possible to select out certain transducers for other reasons, but in general the situation is now physically different from previously known arrays and there are specific advantages in using all of the transducers in the Array for beams in all directions, specifically, increased directivity and increased beam power. These are considerable advantages, especially when taken together with the simplification of beam computations (i.e. no need to compute transducer inclusion/exclusion, even when sweeping beam directions in 2D or 3D).

Applications for such true 3D Arrays are all those for other Array types, plus new applications where the true 3D beam direction (over 4 pi steradians) capabilities are advantageous, and also where an Array of smaller maximum extent but increased directivity and/or radiated power are beneficial (due to the combination of lateral and end-fire directivity characteristics).

The nature of Arrays being that with suitable replacement of transducer drive amplifiers with sensitive receive amplifiers, and replacement of transmission transducers (e.g. loudspeakers) with reception transducers (e.g. microphones), and with suitable modification of the arrangement of the signal processing equipment and summing junctions (all of which is known in the prior art) one may use a similar transmission Array geometric structure as a reception array. This reciprocal behaviour also applies to all of the Arrays of the present invention and it is to be understood that everything that is said here relating to transmission Array loudspeakers, may equally be applied to reception Array microphone systems, and it is intended that such microphone variants are to be included in the present invention.

Preferably, a processor is used to weight the signals routed to each transducer so as to reduce unwanted beams in the sound field. Such waiting is preferably performed in accordance with a windowing function. Preferred windowing functions are sinc functions, cosinusoidal functions and DC offset values. Combinations of these three functions may also be used to achieve the optimum result.

The invention will now be further explained, by way of example only, with reference to the accompanying drawings, in which:

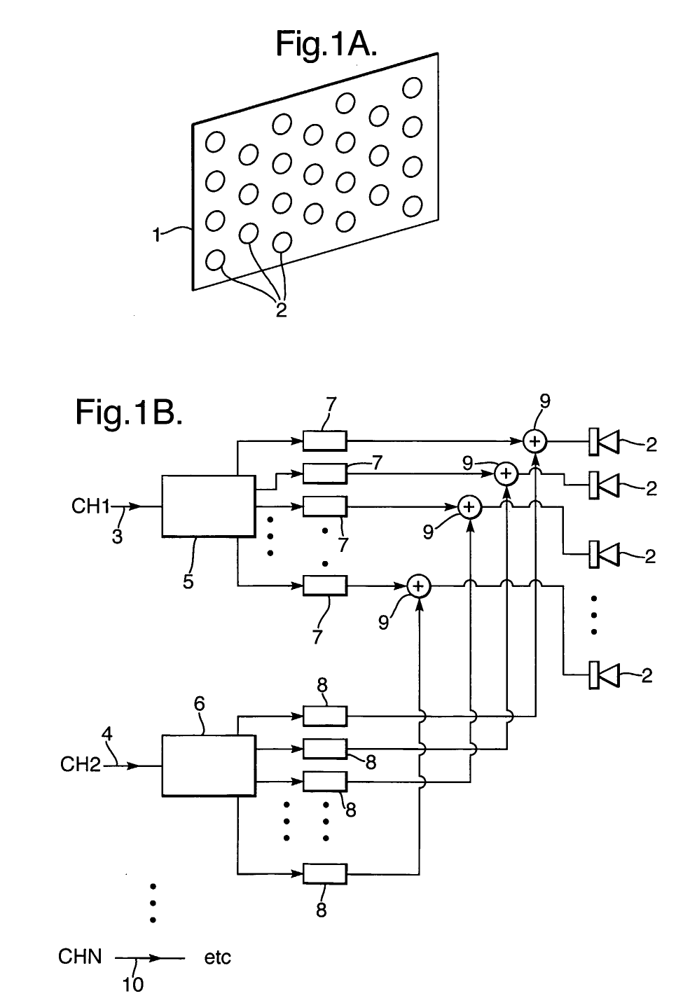

FIG. 1 shows a prior-art planar Array, its conventional delay circuitry, and beam capability;

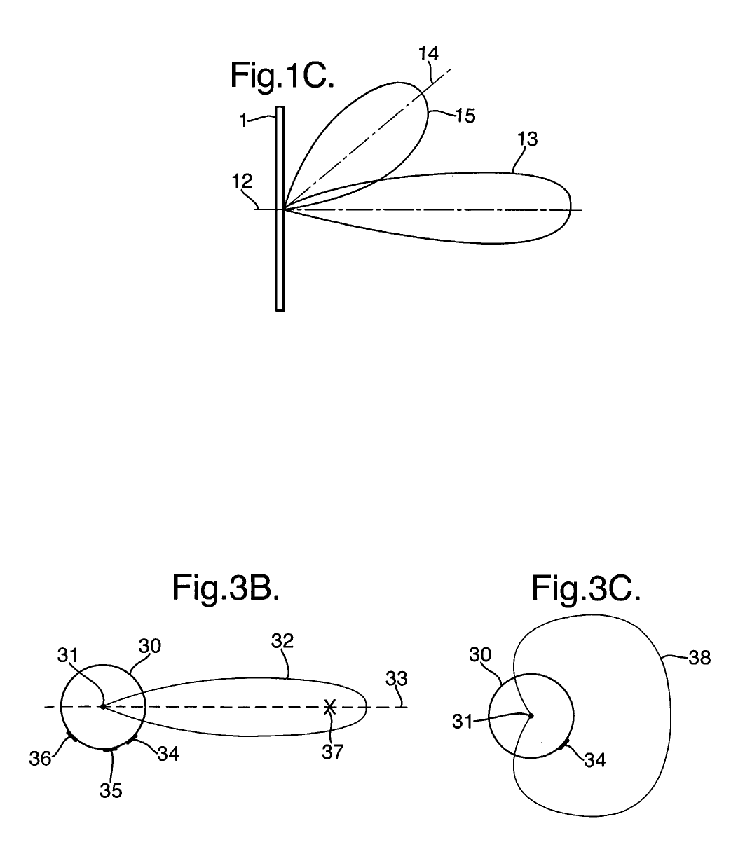

FIG. 2 illustrates various 2D Array shapes according to the present invention;

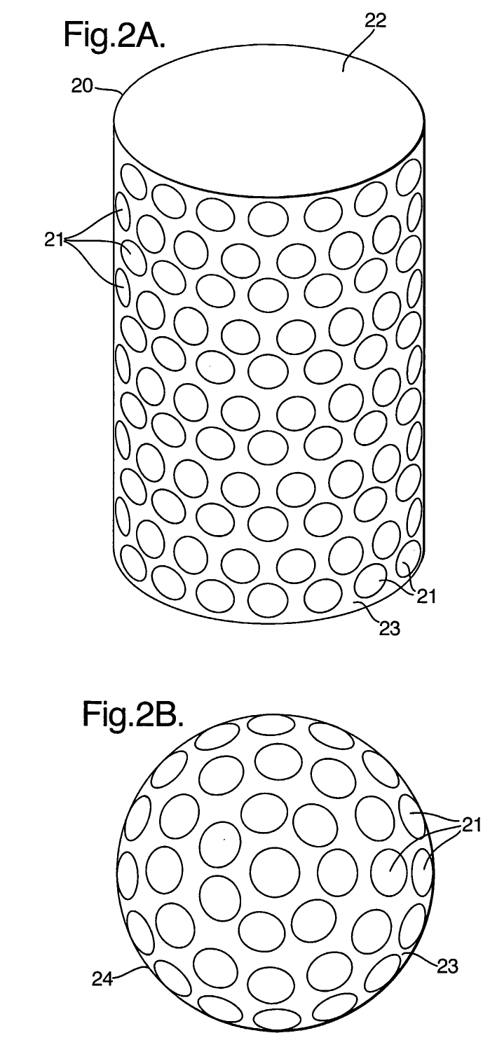

FIG. 3 illustrates the 3D beaming capability of an Array and transducer selection per beam;

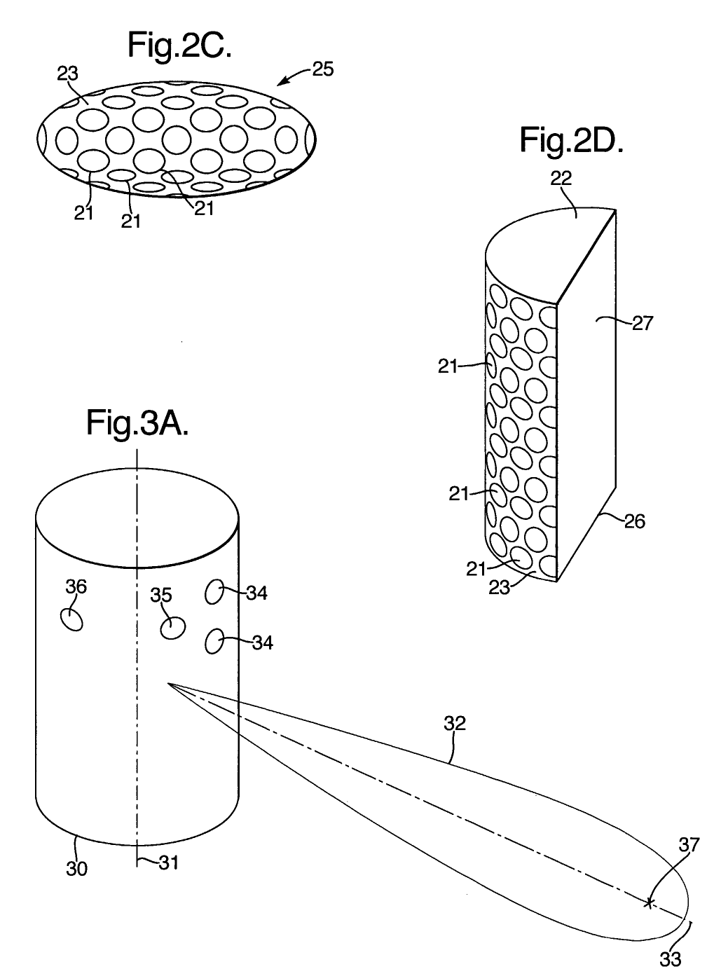

FIG. 4 illustrates the signal processing scheme of an Array of the present invention including the transducer selection means;

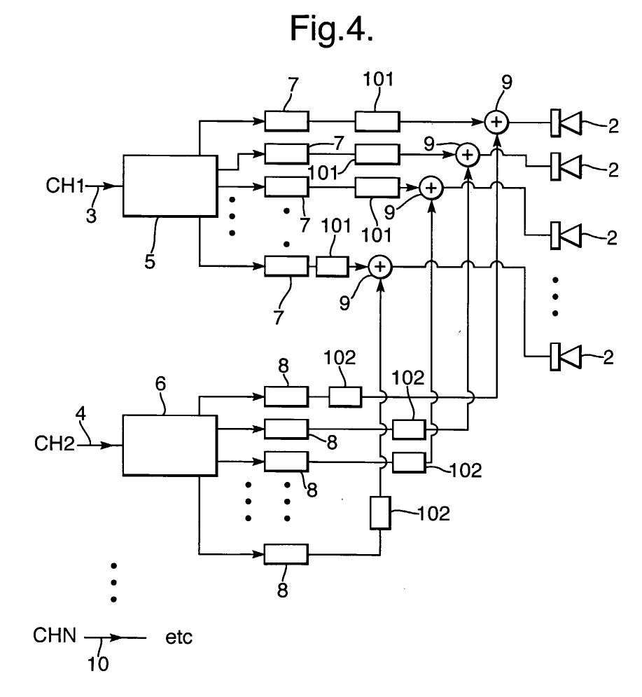

FIG. 5 illustrates the 360 degree beam patterns, and simultaneous multi-direction beams possible with an Array of the first aspect of the invention;

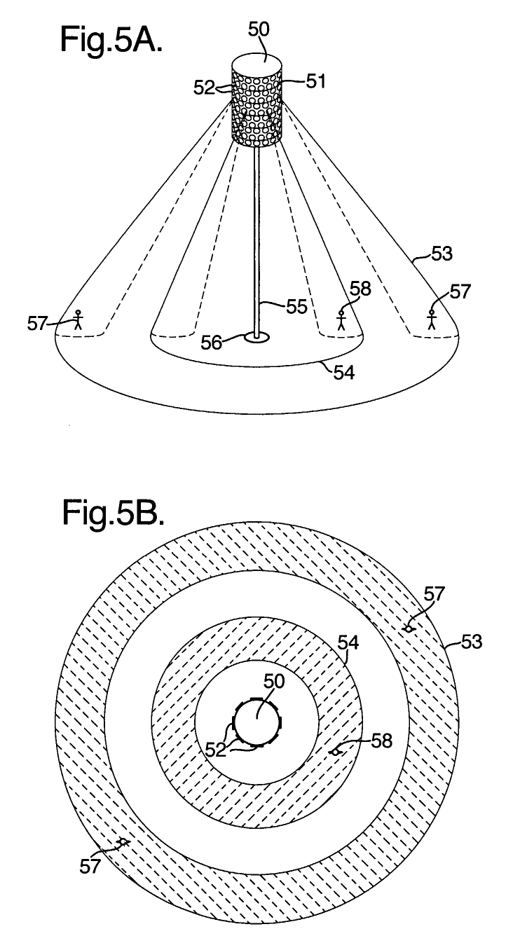

FIG. 6 shows details of possible internal constructions of Arrays of the first aspect of the invention;

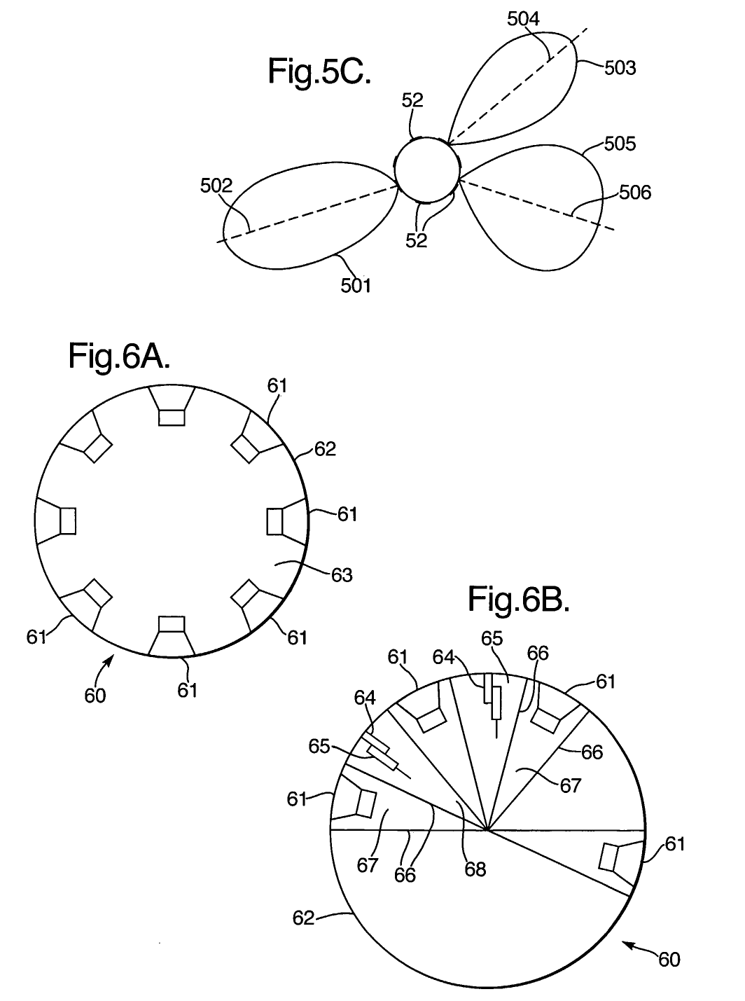

FIG. 7 is a schematic perspective view of a truly 3D Array of the second aspect of the invention;

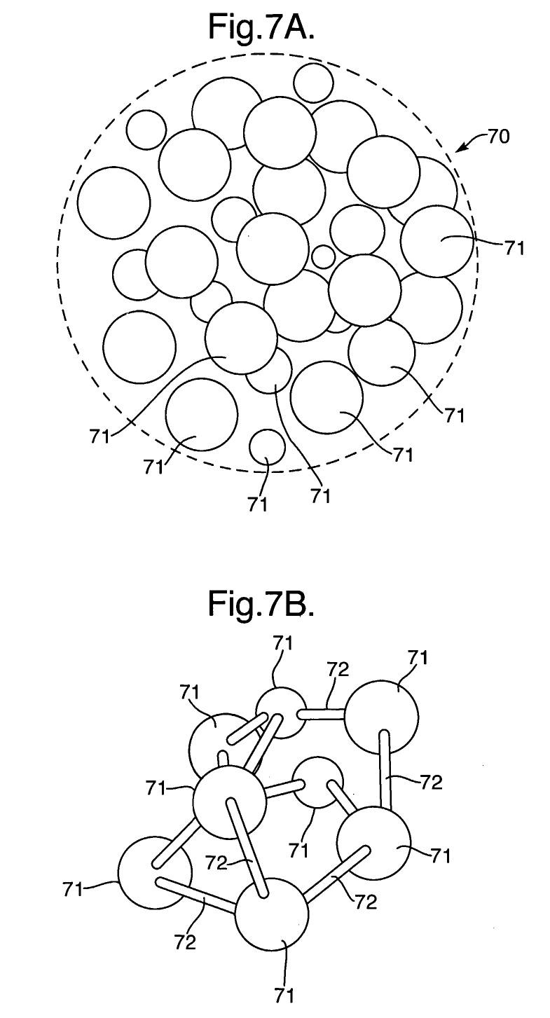

FIG. 8 illustrates the implementation of a cardioid response Array;

FIG. 9 is a graph of a typical weighting function in which transducers at the centre of the array emit sound that it attenuated less than transducers near to the edge of the array;

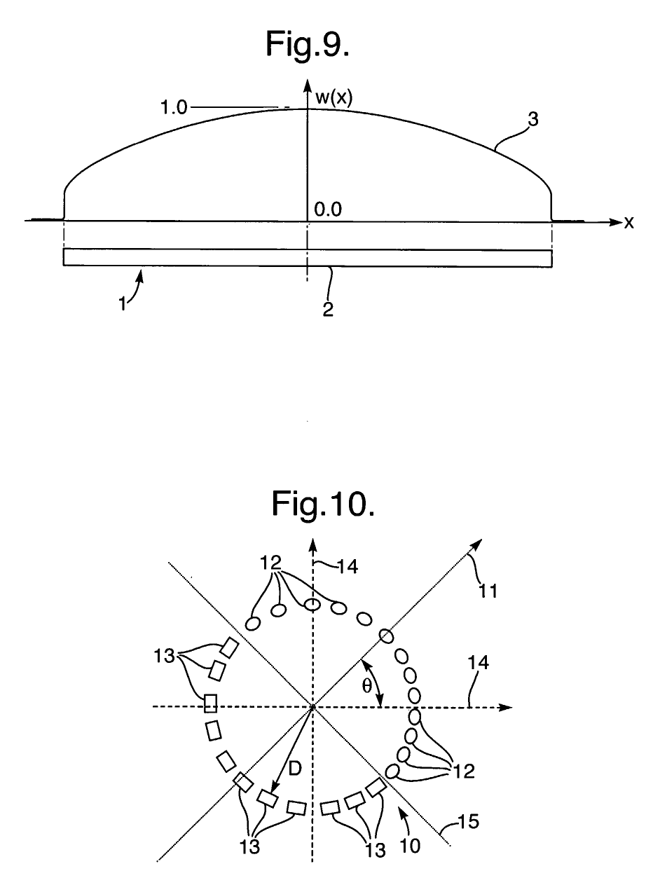

FIG. 10 is a schematic plan view of a cylindrical array and shows which transducers are used to direct a beam in direction 11; and

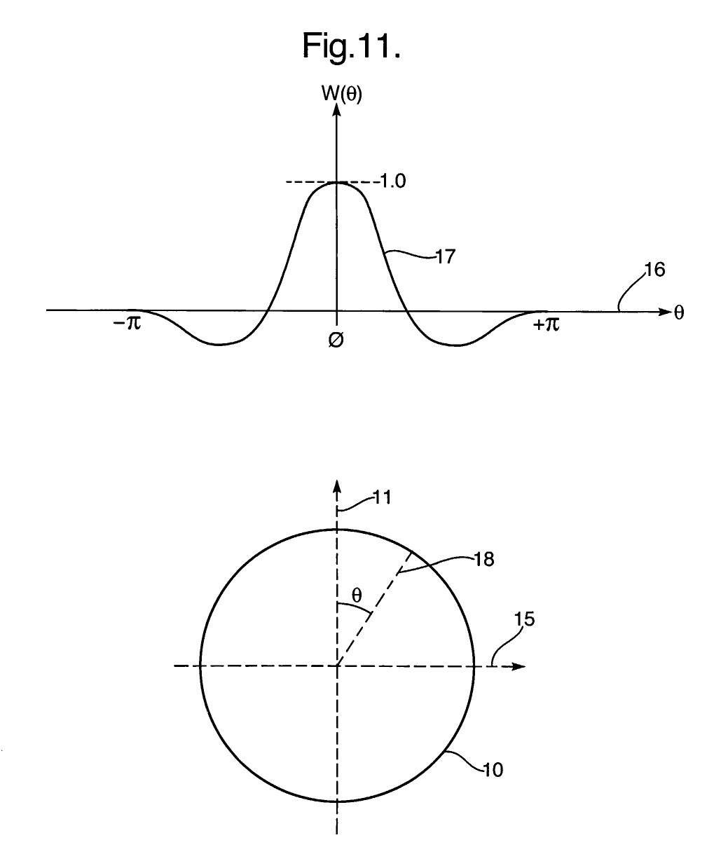

FIG. 11 shows a weighting function that can be applied to a cylindrical array.

These drawings and the ideas embodied in them will now be explained in greater detail.

FIG. 1A shows a schematic perspective view of a prior-art Array 1, comprising a number of acoustic transducers 2 distributed about the frontal area of Array 1 roughly or accurately uniformly, each transducer being driven independently by electronics and signal processing illustrated in simplified overview in FIG. 1B. FIG. 1B shows, for the prior art Arrays, input channels one at 3 and channel two at 4 of N input channels (10 being the Nth input channel) which bring the audio programme material to the Array 1 (Array 1 not shown in FIG. 1B). Input channels 3, 4 . . . 10 connect to signal splitters/distributors 5, 6 respectively (Nth channel not shown in any more detail for simplicity), said splitters distributing copies of their respective input channels to a series of independently adjustable signal delays, delays 7 for channel one at 3, delays 8 for channel two at 4. The signal delay elements 7 and 8 (and from all other channels, not shown for simplicity) feed into summing devices 9 (one summer for each output transducer 2), which add together all the separately delayed components for each transducer for each channel, the outputs of which summers than connect to the acoustic transducers, generally via some type of power amplifiers (not shown for simplicity). At FIG. 1C is seen a schematic of the Array 1 (seen in section from above or from one side, both views of which look similar at this schematic level), with dashed line 12 indicating the Array centre line normal to the plane of the Array. A radiation pattern 13 is illustrated a possible long focus beam shape at a certain frequency produced in an approximately “straight-ahead” direction, whilst at 14 is a second possibly simultaneous beam carrying possibly entirely different audio information, with its principal beam direction shown schematically by dashed line 14. Such an array is disclosed in WO 02/078388.

FIG. 2A shows schematically a perspective view of a cylindrical shaped 2D non-planar Array 20 according to the first aspect of the invention. The multiple acoustic transducers 21 are mounted into a rigid surface 23 with their primary radiating direction outwards from surface 23, and the transducers are distributed over the entire curved surface 23 of the cylinder. The top 22 and bottom (not shown for simplicity/clarity) surfaces of the (truncated) cylinder do not carry any Array transducers, although these areas do provide a convenient location for any additional (effectively non-directional) low frequency woofers to be mounted. In a professional audio implementation of such a cylindrical loudspeaker, it might be practical and convenient (to reduce wiring length and complexity) to mount the drive amplifiers for the transducers 21 inside the cylindrical surface 23, and if said surface was metal or another good thermal conductor, said amplifiers could use surface 23 as a heatsink to cool them, in which case top 22 and bottom cylinder end-caps could be made of mesh for convective or fan assisted cooling of the assembly. FIG. 2B shows schematically a spherical embodiment 24 of the 2D non-planar Array of the first aspect of the invention, with a nominally rigid closed spherical surface 23 penetrated by a number of acoustic transducers 21 with their principal radiating directions facing outwards. FIG. 2C shows a non-symmetric, ellipsoidal Array 25 with transducers 21 distributed over its surface, while FIG. 2D illustrates that it is not necessary to fill the whole curved surface of an Array of this aspect of the invention of transducers, nor even to provide the full closed 2D surface; here transducers 21 are again distributed over the curved surface of what is a half cylinder, while in this case the half cylinder is closed at the back by a flat surface 27 and semicircular end plates 22. The curved surface thus subtends 180°. A quarter cylinder or other fractions may also be used. In all of these Arrays just described, the fundamental signal processing system is the same as shown in FIG. 1B, the only differences being that the transducers are now laid out in three dimensions and the delays 7, 8 etc must be computed taking into account all three dimensions, and that an additional programmable transducer selection per beam facility is needed, which may be visualised as being a new additional component of the signal processing delay elements 7, 8 etc in FIG. 1B, which allows the gain of these elements to be adjusted accordingly (e.g. gain=1 for inclusion in any given beam, gain=0 for exclusion, and 0<=gain<=1 for more subtle beam shaping, windowing and partial transducer selection systems.

FIG. 3A is a perspective schematic of a cylindrical variant of an Array 30 according to the first aspect of the invention, with an axis of symmetry 31, and beam direction represented by dashed line 33 passing through Focal Point 37, the beam shape in this direction being represented in polar form by curve 32. Not all the transducers are shown for clarity. Certain transducers 34 are well within the region of curved surface of 30 in line of sight to the focal point and are recruited in forming beam 32 in this direction. Transducer 35 is marginally within line of sight of 37 and may or may not be used to contribute to the beam. Transducer 36 is on the opposite side of the cylinder 30 from the Focal Point and not within line of sight, and would not be used to contribute to the particular beam (direction) 32 (33).shown. Fig, 3B is a plan view schematic of the same situation as shown in FIG. 3A, where the geometric relationship between the various same-numbered components can be seen more clearly. Note that in this view the beam 32 is also shown as a pencil beam in direction 33, although there is no necessity for the beam cross section to be similar in different orientations relative to the beam direction. Thus in FIG. 3C, another plan view of cylindrical Array 30, the beam 38 in the plane normal to cylinder axis 31 is seen to be very much broader (extending for more than pi rads around axis 31) than the beam width in the plane parallel to the axis 31 which might still be as narrow as shown in FIG. 3A at 32.

FIG. 4 shows the addition of transducer selection means 101, 102, . . . on a per beam basis in the simplified schematic signal processing system of an Array of the first aspect of the invention. It will be seen that this system is similar to the prior art scheme shown in FIG. 1B with the addition of a selection coefficient means 101 in each transducer feed prior to the summer junctions for channel one, a similar set of transducer selection means 102 in each transducer feed prior to the summers for each transducer for channel two, and so on, and all of these are independently programmable by a controller (not shown for clarity), which determines which transducers are to be used in which of possibly many simultaneous beams. Note that although the selection coefficient means 101, 102 . . . are shown following the delay elements 7, 8 in the signal processing path, they could equally usefully precede, or indeed be combined with these delay elements, or instead they could be combined with the input circuits of the summer junctions 9, or combined with the output circuits of the distributors 5, 6 . . . , all of which would achieve the same effect equally well.

FIG. 5A is a schematic perspective illustration of a cylindrical form of the Array 50 of the present invention, supported some way off the ground 56 by a pole 55 (which could equally be a wire support from the ceiling or other suspension/support system), with transducers 52 (only two shown for clarity) on its outer curved surface51, producing two simultaneous circularly symmetric sound beams 53 and 54, each beaming down towards the ground level 56 but at different angles to the horizontal, 54 being steeper than 53, and thus flooding the area closer around the base of 55 and preferentially reaching people 58 in this vicinity, while beam 54 intersects the ground further away from the base of 55 and thus preferentially reaches people 57 further away from the pole 55. FIG. 5B again schematically shows a plan view of the same situation where the numbers refer to the same features as in FIG. 5A. Here it can be seen that the main part of beam 54 (inner shaded area), i.e where that beam is most intense, covers an area in this case circular in shape, which does not necessarily intersect or overlap with the area covered by beam 53 (outer shaded area), and thus the possibility arises of distributing different sounds or audio programme material to the people in these two different areas (e.g. 58, and 57).

FIG. 5C shows another schematic plan view of a cylindrical Array 50 of the present invention in this case generating three beams 501, 503, 505 in directions shown by the dashed lines 502, 504, 506, each of which beams may carry independent and different audio information, or perhaps the same audio information distributed around the Array 50 in a special, non-uniform manner. Note that although shown as similar, it is possible for the three different beams 501, 503, 505 to have different beam shapes as well as different focal lengths, if that is desired.

FIG. 6A shows schematically a plan-view cross section through a cylindrical Array 60 of the present invention, showing a number of transducers 61 set into the solid rigid acoustically closed curved (or faceted) surface 62 of the cylindrical support structure of Array 60, each transducer 61 at its rear “venting” into the shared acoustic volume 63 (which might usefully be part or fully filled with acoustic absorption material). The top and bottom end caps of the cylinder (not shown) would then form sealed acoustic closed walls to trap the rear transducer radiation within the volume 63. An optional bass reflex port might be added to improve low frequency, non-directional radiation. Note that only one “ring” of transducers 61 is shown for clarity, whereas a practical implementation of Array 60 might have between one and ten, twenty, thirty or even forty or more rings of transducers, depending on the power output required, and directivity needed.

FIG. 6B shows schematically a plan-view cross section through a cylindrical Array 60 of the present invention of alternative construction to that of FIG. 6A, showing a number only a few shown for clarity) of transducers 61 set into the solid rigid acoustically closed curved (or faceted) surface 62 of the cylindrical support structure of Array 60, each transducer 61 at its rear “venting” into its own acoustic volume 67 (which might usefully be part or fully filled with acoustic absorption material). In this form these closed per-transducer volumes are partitioned off from the entire internal volume of cylinder wall 62, by panels 66 arranged to separate acoustically individual transducers, whilst enclosing as much volume as practicable. Where the wall 62 and or the partitions 66 or made of metal or other good thermal conductor, then the power drive amplifiers 65 required, one per transducer, may usefully be positioned adjacent to their respective transducers and thermally coupled to either the panels 66 or the wall 62 to act as integral heatsinks for the amplifiers. In this case the volumes 68 surrounding each amplifier (and acoustically isolated from the rears of the transducers), may all be coupled and air encouraged to pass through these volumes (either by convection if the cylindrical array 60 is vertical, or by fan assisted flow), to further cool the power amplifiers. In this case the top and bottom end-caps of the cylinder may be made of mesh or other non-airflow blocking material. The partitioned volumes 67 behind each transducer have their own local top and bottom end caps (not shown) to preserve acoustic isolation between each other. Note that only one “ring” of transducers 61 is shown for clarity, whereas a practical implementation of Array 60 might have between one and ten, twenty, thirty or even forty or more rings of transducers, depending on the power output required, and directivity needed.

FIG. 7A is a schematic perspective view of a truly 3D Array 70 (whose extent is approximately indicated by the dashed line, but which has no necessarily well defined boundary) of another aspect of the invention, comprising a number of transducers 71 (only some of which are shown for clarity, and fewer still of which are numbered) distributed over and throughout a region of 3D space (in this example a roughly spherical such region) and held in fixed relative locations by an effectively acoustically transparent support structure (not shown for clarity) which could be for example a web of thin stiff interconnecting struts connecting between adjacent pairs of transducers. In FIG. 7 each of the circles represents a single transducer of the same real size, and the differing circle sizes is intended to indicate depth in space (into the page) with more distant transducers represented as smaller circles, with the nearer, foreground transducers in some case partially occluding the further away transducers. There are necessarily gaps between the transducers, essential for the transmission of sound from each transducer approximately in all directions in space (there will be some reflection, refraction and diffraction of sound amongst the collection of transducers). The transducers themselves are chosen or designed to be as omnidirectional as possible over the range of audio frequencies to be generated by the Array, and one way of achieving this is to make the transducers small compared to a wavelength of the highest frequency of interest. Such a choice of small size will also result in minimal reflection of sound energy off each transducer. Note that by comparison with other Arrays described herein and in the prior art, this novel 3D Array has no “cabinet” or other general internal volume nor any outside rigid acoustically closed and opaque surface. The transducers themselves should preferably be effectively monopole sources, and not dipole sources, although with certain additional signal processing some useful but compromised performance is still possible using dipole sources.

FIG. 7B shows in more detail how several of the transducers 71 of the Array 70 illustrated in FIG. 7A, might be mechanically interconnected and mutually supported by struts 72. The complete assembly may then be hung or otherwise supported with an external structure (not shown) mechanically connected to one or more struts 72.

FIG. 8A shows a schematic plan view through a section of a cylindrical Array 100 to be used to synthesise a cardioid beam response. The axis of said cylinder is shown as a dot at 140 and an imaginary line normal to the axis and passing through it is shown at 130. The transducers 110 below line 130 (in the drawing) are all driven in-phase, while the transducers 120 above line 130 (in the drawing) are driven in antiphase to those at 110. Note that in the Array all transducers 110 and 120 are all at approximately the same position along axis 140 of said Array. Thus this “ring” of transducers illustrated has a dipole radiation pattern in the plane through 140, 110 and 120, because of the antiphase drive scheme. If the ring of transducers immediately above or below this one shown, were to be all driven in-phase with transducers 110 (say) then this latter ring would be a monopole in the plane of its transducers, and nearly coincident with the dipole adjacent to it, along the cylinder. The net radiation pattern is shown in FIG. 8B where axis 140 points along the direction of dashed-line 130 in FIG. 8A, axis 150 is orthogonal to 140 and in the plane of transducers 110 and 120, and closed curve 180 is a sketch representation of the polar pattern of the Array 110 in said plane with a strong maximum at 181 along the direction 150 (normal to the direction of 130) and a strong null at 182 in the opposite direction. FIG. 8C is a schematic of the same cylindrical Array 100, showing three adjacent rings of transducers, 82, 81 and 83, along the axis 84 direction of the cylinder. As per the scheme just described, ring 82 of transducers, for example, could all be driven in-phase, whereas ring 81 would have half the transducers (in an adjacent set) driven in-phase with 82, and the other half (on the other side of axis 84) would be driven in anti-phase. This pattern would then be repeated along the cylinder, continuing with ring 83 and thereafter.

Suitable windowing (apodization) techniques applicable to non-planar arrays will now be discussed. Consider a practical cylindrical 3D DDAA wherein a truncated cylindrical form of diameter D and height H, has its surface covered with elements in a regular triangular grid pattern, over all 360deg around the cylinder and over the entire extent H of the cylinder's height. Such a device is sketched in FIG. 2A.

There are 3 cases to be examined.

Case 1: Here the wavelength L of the radiation is small compared with the cylinder diameter D, i.e. L<<D;

Case 2: Here the wavelength L of the radiation is similar to the cylinder diameter D, i.e. L˜D;

Case 3: Here the wavelength L of the radiation is large compared with the cylinder diameter D, i.e. L>>D;

For the purposes of discussion we will consider only the transmission array case, used for acoustic waves, but it will be evident to those versed in the art that similar principles apply to the receiving antenna case, and to other wave types than acoustic (with suitable change of wave velocity etc).

We also make the assumption that the array elements are nominally all of the same diameter d, and are hemi-omnidirectional (i.e. radiate approximately equally in all directions outside a tangent plane to the cylinder passing through each element's centre point) over their useful working frequency range, and fully omnidirectional at lower frequencies where the wavelength is very much greater than their diameter d, again without loss of generality.

In Case 1, L<<D. Consider a requirement to form a radiated sound beam from the 3D DDAA (hereinafter just called the cylinder) in a given direction theta relative to some axes fixed in the centre of the cylinder, and we consider without loss of generality (but with less detail required) only the case where the beam is to be radiated in the direction orthogonal to the central axis of the cylinder. Then, all of the array elements in the hemi-cylinder centred on direction theta have line of sight to the beam direction (the ones at the edge of this hemi-cylinder are marginally so) and all may contribute usefully to the beam. One computes their respective delays in order to form such a beam in the usual way for DDAAs taking into account not just their distance across the array but also their 3D coordinates (i.e. their varying distance from a plane orthogonal to the beam direction), as these will now vary considerably as the array is cylindrical, not planar.

The remainder of the transducers (in the opposite hemi-cylinder) cannot usefully contribute to the beam, as the cylinder itself effectively blocks their radiation, because L<<D. So using an un-apodized array will clearly produce unwanted radiation, a spurious beam of some kind, in a direction opposite to the desired beam direction, as all of these latter transducers are effectively isolated from the ones in the other hemi-cylinder by the physical structure of the cylinder, and so no destructive interference on the far side of the cylinder from the beam can take place (utilising the radiation from elements on the near side to the beam) as would normally occur in a DDAA. This is a new problem, arising from the 3D nature of the DDAA structure.

This situation is depicted in FIG. 10, where a cylindrical array 10 is seen in plan view, comprising array elements partially numbered 12 and 13, with a schematic desired beam direction 11 shown as an arrow and a dotted line at angle theta to some datum axes drawn with dashed lines. The dotted line 15 depicts a line orthogonal to the desired beam direction 11. Array elements 12 depicted as elipses lie on the same side of line 15 as the desired beam 11; whereas array elements 13 depicted as small rectangles lie on the opposite side of line 15 from the desired beam direction 11. Given that the array element sets 12 and 13 are inserted into the otherwise solid surface of cyclindrical array 10, it is apparent from the drawing that all of the elements 12 have an unimpeded line of sight in direction 11, whereas none of the elements 13 have such a line of sight, the cylinder 10 blocking this line of sight. When wavelength L<<D the diameter of the cylinder, then the cylinder effectively acts as an infinite baffle for each transducer, and each radiates effectively into a half-space.

It is a purpose of the present invention to eliminate or at least reduce this problem, i.e. the unwanted spurious beam. We find by analysis and experiment that the spurious beam may be greatly diminished in Case 1 by using an apodization function of the following form:

First, as we are only considering for simplicity beams in a plane orthogonal to the cylinder axis, the apodization function will be constant along the surface of the cylinder in a direction orthogonal to this plane (i.e. constant up and down the length of the cylinder), although in practice this direction may be usefully weighted with the usual candidate functions such as raised cosine etc to taper the array in the length-of-cylinder direction to minimise sidelobes in this direction. So we will only further consider the shape of the apodization function in the plane around the cylinder axis.

Second, we find that apodization functions that are approximately or actually symmetrical in this latter plane about the beam direction are most effective.

Thirdly, we find that apodization functions which are of the following form are very effective:
a) They have a maximum (nominally unity) in or close to the direction of the beam;
b) The apodization function should take the form of a decaying oscillatory shape either side of the central maximum, most specifically with half cycles of oscillation taking negative weights, whereas by comparison the central maximum of the function has a positive weight;
c) Such functions having at least one 1/4 positive half cycle beginning at the beam direction, and at least 12or close to one half negative half cycle further away from the beam direction, in each half of the cylindrical circumference are functionally useful;
d) Such oscillatory apodization functions having multiple positive and negative half cycles around each half of the cylinder circumference are more effective still at minimising rear-direction unwanted beams;
e) A sinc function weighting or similar function, apodization around the cylinder circumference, with said function centred on the beam direction is particularly effective.

FIG. 11 shows one such example. Here the DDAA is represented by the cylinder 10 seen in plan view, with some axes 11 and 15 shown as dotted lines with the 11 axis pointing in the desired beam direction. The dashed line 18 represents some other direction, angle theta away from the axis 11. The weighting function w(theta) 17 is shown to the right in the Figure, and will be seen to have unit value at theta=0.0, a main positive “half-cycle” centred around theta=0.0, and two negative half-cycles in the directions approaching theta=+or −pi (these latter two directions being directly opposite the direction 11 shown on the cylindrical plan view).

Of course, there are very many such oscillatory functions that may be used to good effect.

The point to notice is that we are using the sine function weighting here in a new situation, the 3D DDAA, and to achieve a different purpose than previously—i.e. to minimize unwanted beams due to the blocking effect of the physical structure of the 3D DDAA itself, rather than to simply achieve a modified (e.g. flatter) beam pattern as is the case when sinc functions are used in planar DDAAs.

In addition to characteristics a) to e) above, we also find that useful additional features may be added to the apodization function as follows:
f) A fractional weighted sum of an apodization function as described in a) to e) together with a fractional weighted sum of a more conventional weighting function such as a raised cosine, can produce additional beneficial beam shaping and rear beam reduction, depending precisely on the relative sizes of L and D.
Case 2: In Case 2, L˜D. This is a difficult region of operation to produce beams from just one side of a 3D DDAA.
Case 3: In Case 3, L>>D. Array element diameter d is necessarily<<D. Thus L>>d=>L>>d. Because of diffraction effects, and because the cylinder is much smaller than a wavelength, then the omnidirectional characteristics for L>>d of the array elements ensures that their radiation patterns far from the cylinder are largely unaffected by the presence of the physical structure of the cylinder, and thus they radiate (in the far field) just about equally in all directions, including the direction to the opposite side of the cylinder from each element's location.
We then find the somewhat surprising result that using a uniform apodization function, or equivalently, an unapodized array, can generate a beam in a desired direction with little or no beam in the opposite direction. This is counterintuitive and thus in itself a surprising result.

Case 2 requires a transitional, intermediate apodization function, between that for Case 1 (e.g. a sinc function) and that for Case 3 (a flat apodization function).

When the cylinder height H is large compared with a wavelength (H>>L) then in the direction of the cylinder axis it is desirable to apply either a uniform apodization function (for maximum radiation sensitivity and beam sharpness, but with larger sidelobes in this direction, or one of the conventional apodizations such as raised cosine.

For a spherical or ellipsoidal DDAA the results just described for the cylindrical DDAA for the plane orthogonal to the cylinder axis, may be applied also to the orthogonal direction, so that for example, an apodization function in the form of, e.g. a 2D sinc function centred on the desired beam direction, will work well for the case D>>L; and again surprisingly for the converse case where D<<L a uniform apodization function over the entire spherical/ellipsoidal array will work well in the sense of minimising unwanted rear-direction beams.

1. Apparatus for creating a sound field, said apparatus comprising:
an array of sonic output transducers, which array is capable of directing at least one sound beam in a selected direction;
wherein said transducers lie on a curved surface subtending 90° or more.

2. Apparatus according to claim 1, wherein said transducers have their primary radiating directions perpendicular to the tangent of the curved surface at the point where they lie.

3. Apparatus according to claim 1, wherein said apparatus is capable of directing two sound beams in opposite directions simultaneously.

4. Apparatus according to claim 1, wherein said curved surface is a physical surface.

5. Apparatus according to claim 1, wherein the curvature of the surface has a single sign over its whole extent.

6. Apparatus according to claim 1, wherein said curved surface is convex over its whole extent.

7. Apparatus according to claim 1, wherein said curved surface subtends 90°.

8. Apparatus according to claim 1, wherein said curved surface subtends 180°.

9. Apparatus according to claim 1, wherein said curved surface is substantially cylindrical.

10. Apparatus according to claim 9, wherein there are at least six transducers spaced apart around the circumferential direction of the cylinder.

11. Apparatus according to claim 9, wherein there are at least three transducers spaced apart along the longitudinal direction of the cylinder.

12. Apparatus according to claim 9, further comprising a processor arranged to drive transducers lying in one 180° segment in antiphase with transducers lying in the other 180° segment.

13. Apparatus according to claim 9, further comprising a processor arranged to drive transducers at the same longitudinal position together.

14. Apparatus according to claim 1, wherein said curved surface is substantially spherical.

15. Apparatus according to claim 1, further comprising a processor arranged to determine a first subset of transducers to use when directing sound in a first direction.

16. Apparatus for creating a sound field, said apparatus comprising:
an array of sonic output transducers, which array is capable of directing at least one beam in a first selected direction;
wherein said transducers lie on a curved surface; and
wherein said apparatus comprises a processor arranged to determine a first subset of transducers to use when directing sound in said first direction.

17. Apparatus according to claim 16, wherein said transducers have their primary radiating directions perpendicular to the tangent of the curved surface at the point where they lie.

18. Apparatus according to claim 16, wherein said first subset is determined by said processor in accordance with said first direction such that said first subset contains only transducers that have an unimpeded component of radiation in a direction which contributes to a beam in said first direction.

19. Apparatus according to claim 16, wherein said processor is arranged to de-energise transducers of said array not in said first subset.

20. Apparatus according to claim 16, wherein said first subset is determined by said processor so as to contain only those transducers which have a predetermined minimum sound pressure level in a direction which will contribute to the beam in said first direction.

21. Apparatus according to claim 1, further comprising a processor arranged to weight the signals routed to each transducer so as to reduce unwanted beams in the sound field.

22. Apparatus according to claim 21, wherein said signals are weighted in accordance with a sinc function centred on the transducer closest to a point on a line from the centre of gravity of the array lying in the desired beam direction.

23. Apparatus according to claim 21, wherein said signals are weighted in accordance with a cosinusoidal function.

24. Apparatus according to claim 21, wherein said weighting comprises a dc offset value.

25. A method for creating a sound field, said method comprising:
providing an array of sonic output transducers which lie on a curved surface subtending 90° or more; and
directing a beam of sound using said array.

26. A method for creating a sound field, said method comprising:
providing an array of sonic output transducers which lie on a curved surface;
selecting a direction in which to beam sound;
selecting a first subset of transducers in accordance with said direction such that said first subset contains only those transducers that have an unimpeded component of radiation in a direction which contributes to a beam in said selected direction;
using only said first subset of transducers to beam sound in said selected direction.

27. A method according to claim 24, wherein said transducers lie with their primary radiating directions perpendicular to the tangent of the curved surface at the point where they lie.

28. A cylindrical sonic transducer array comprising a plurality of sonic output transducers distributed over the surface of a cylinder with their primary radiating directions lying along a radius of the cylinder.
